(19) United States
(12) Patent Application Publication
(10) Pub. No.: US 2014/0306919 A1
(43) Pub. Date: Oct. 16, 2014

(54) TABLET DEVICE, INFORMATION DISPLAY METHOD, DISPLAY SYSTEM, AND DISPLAY METHOD

(71) Applicant: NEC CASIO MOBILE COMMUNICATIONS, LTD., Kawasaki-shi, Kanagawa (JP)

(72) Inventors: Motoshi Tanaka, Saitama (JP); Yukiko Yoshino, Saitama (JP)

(21) Appl. No.: 14/360,122

(22) PCT Filed: Dec. 4, 2012
(86) PCT No.: PCT/JP2012/081345

§ 371 Date: May 22, 2014

(30) Foreign Application Priority Data
Dec. 7, 2011 (JP) 2011-267657
Dec. 16, 2011 (JP) 2011-275599

(51) Int. Cl. G06F 3/14; G06F 3/041

(52) U.S. Cl. CPC G06F 3/1462; G06F 3/041
USPC 345/173

(57) ABSTRACT

When display screen information (A) displayed on the screen of a smartphone (100) that is equipped with a vertical screen and operated while being held in a vertical state is acquired and displayed on a tablet device (200) that is equipped with a horizontal screen and operated while being held in a horizontal state, if the display screen information (A) acquired from the smartphone (100) is not for use on a horizontal screen, the display screen information (A) is rotated 90 degrees and enlarged and displayed at the same vertical/horizontal aspect ratio to fill the screen of the tablet device (200).

### TECHNICAL FIELD

The present invention relates to a tablet device, an information display method, a display system, and a display method that displays information.

### BACKGROUND ART

Recent years have seen the popularization of smartphones, i.e., highly functional mobile terminals equipped with telephone functions and information processing functions.

When connecting a smartphone to a tablet device, users expect to be able to read, for example, mail and to manipulate menus that are displayed on a display that is larger than the display of a smartphone. However, when a smartphone that is equipped with a vertical screen and that is operated while being held in a vertical state, is connected to a tablet device that is equipped with a horizontal screen and operated while being held in a horizontal state and when display screen information that is displayed on the smartphone screen is displayed on the screen of the tablet device, the problem arises that, if there is no layout for a horizontal screen in the display screen information that is displayed on the smartphone screen, the layout for vertical screen will be displayed as is on the screen of the tablet device, with the consequence that enlarged display that takes advantage of the larger screen of the tablet device cannot be achieved. In particular, when the vertical resolution of the tablet device is smaller than the vertical resolution of the smartphone (for example, when the vertical resolution of the smartphone is 800 dots and the vertical resolution of the tablet device is 600 dots), the display screen information that is displayed on the smartphone screen is merely displayed as an image that is centered and reduced at the vertical/horizontal aspect ratio in conformance with the vertical resolution of the tablet device. As a result, rather than an enlarged display, a reduced display is shown in which the horizontal format of the tablet device is not used.

In addition, when the tablet device is switched from being held in a horizontal state to being held in a vertical state, the problem arises that, even when a game or application that uses an acceleration sensor is being used, the tablet device recognizes the direction that is orthogonal to the horizontal orientation as the vertical direction and does not allow use while being held in a vertical state.

FIG. 11a shows a display method for a case in which display screen information that is displayed on a smartphone screen is for a vertical screen. FIG. 11b shows a display method for a case in which the display screen information that is displayed on a smartphone screen is for a horizontal screen.

As shown in FIG. 11a, in a case in which display screen information A that is displayed on the screen of smartphone 500 that is equipped with a vertical screen and that is operated while being held in a vertical state, is displayed on tablet device 600 that is equipped with a horizontal screen and that is operated while being held in a horizontal state, if display screen information A that is displayed on the screen of smartphone 500 is for a vertical screen, even when smartphone 500 is connected to tablet device 600 and display screen information A is enlarged and displayed on tablet device 600, display screen information A will be displayed centered without being enlarged if the resolution in the vertical direction of tablet device 600 is not greater than the resolution in the vertical direction of smartphone 500. When tablet device 600 is rotated 90 degrees, the direction that is recognized as the downward direction in tablet device 600 will differ from the direction of gravity.

On the other hand, in a case in which display screen information A′ that is displayed on the screen of smartphone 500 is for horizontal screen use, when smartphone 500 is connected to tablet device 600, display screen information A′ a for horizontal screen will be enlarged and displayed, as shown in FIG. 11b. This is because display screen information A′ was originally prepared separately from display screen information A for a vertical screen that is displayed on the screen of smartphone 500.

Technology has been considered in which, by connecting a mobile telephone to an external display device, information that is displayed on the mobile telephone is enlarged and displayed on the external display device, and such a technique is disclosed in Patent Document 1.

Although a smartphone has the advantages of being small, lightweight, and easy to carry, there are cases in which the use of a larger screen is desired, such as when viewing a television broadcast or a moving image.

In such cases, a method has been developed by which a smartphone is connected to a personal computer such as a desktop, notebook, tablet computer or to a television receiver that has a screen size that is larger than the smartphone and the displayed image of the smartphone is then displayed on the screen of computer or television receiver.

The display of the information of a mobile terminal on a display device having a larger screen is also described in, for example, Patent Document 1. Patent Document 1 describes not only the enlarged display of an image that is displayed on a mobile terminal on an external display device but also describes the use of the mobile terminal as an input device (mouse).

In addition, the alteration of the display direction of a mobile terminal based on the output value of an acceleration sensor is described in, for example, Patent Document 2. The alteration of the display direction of a tablet terminal that is a tablet computer based on the output value of an acceleration sensor is described in, for example, Patent Document 3.

### LITERATURE OF THE PRIOR ART

### Patent Documents

Patent Document 1: Japanese Unexamined Patent Application Publication No. 2010-165289
Patent Document 2: Japanese Unexamined Patent Application Publication No. 2010-263433
Patent Document 3: Japanese Unexamined Patent Application Publication No. 2008-139711

### SUMMARY OF THE INVENTION

### Problem to be Solved by the Invention

Nevertheless, the technique disclosed in Patent Document 1 relates only to display of information that is displayed on a mobile telephone on an external display device in which the information has been enlarged in the same orientation and therefore cannot solve the problem described above.

In addition, although the enlarged display on an external display device of the information of a mobile terminal is shown in Patent Document 1, the display direction of the screen is fixed regardless of the inclination of the mobile terminal or external display device.

On the other hand, as described in Patent Documents 2 or 3, the incorporation of an acceleration sensor in the mobile terminal or tablet terminal enables detection of the inclination of the mobile terminal or tablet terminal based on the output value and thus enables alteration of the display direction according to inclination. However, the configurations described in Patent Documents 2 and 3 use the output value of acceleration sensors that are incorporated in each of the mobile terminal and tablet terminal to separately control the display direction of the mobile terminal and tablet terminal, and there is no disclosure regarding a method of controlling the display direction of the tablet terminal when the mobile terminal and tablet terminal are connected.

The present invention was realized in view of the above-described problem inherent to the prior art and has as an object the provision of a tablet device and an information display method that can take advantage of the larger screen of a tablet device to realize the enlarged display of the display screen information that is displayed on a smartphone.

The present invention further has an object of providing a display system and display method that enable optimum control of the display direction when information of a mobile terminal is displayed on an external device.

### Means for Solving the Problem

The present invention for achieving the above-described objects is a tablet device that is equipped with a horizontal screen, that is operated while being held in a horizontal state, and that is configured to allow connection to a smartphone that is equipped with a vertical screen and that is operated while being held in a vertical state, comprising:

information acquisition means configured to acquire display screen information that is displayed on the screen of the smartphone; and

control means configured to, when the display screen information that was acquired by the information acquisition means is not for a horizontal screen, rotate the display screen information 90 degrees and to enlarge and display the display screen information at the same vertical/horizontal aspect ratio within a layout frame that accords with the horizontal screen.

The information display method of acquiring and displaying display screen information that is displayed on the screen of a smartphone that is equipped with a vertical screen and that is operated while being held in a vertical state on a tablet device that is equipped with a horizontal screen and that is operated while being held in a horizontal state, wherein:

when display screen information that was acquired from the smartphone is not for horizontal screen use, is rotated 90 degrees and enlarged and displayed, at the same vertical/horizontal aspect ratio, within a layout frame according to the horizontal screen.

In addition, display system that includes:

a mobile terminal that is equipped with an interface that connects with an external apparatus so as to allow transmission and reception of information; and

a display device that is equipped with the interface that connects with the mobile terminal so as to allow transmission and reception of information and a display unit having a screen size larger than that of the mobile terminal,

wherein the mobile terminal:

when connected with the display device by way of the interface, judges the possibility of automatic layout that displays images that conforms to a vertically oriented state in which shorter sides are oriented with the horizontal direction or to a horizontally oriented state in which longer sides are oriented with the horizontal direction;

when the automatic layout is supported, transmits to the display device image data for displaying images that conform to the state of the display device that corresponds to the vertically oriented state or the horizontally oriented state; and

when the automatic layout is not supported, transmits to the display device image data for displaying images of a display direction that was determined in advance.

The display method for, when a mobile terminal that is equipped with an interface that connects with an external apparatus so as to allow the transmission and reception of information, and a display device that is equipped with the interface that connects with the mobile terminal so as to allow the transmission and reception of information and a display unit that has a screen size larger than the mobile terminal are connected by way of the interface, displaying information of the mobile terminal on the display device; wherein the mobile terminal:

when connected to the display device by way of the interface, judges the possibility of automatic layout that displays images that conform to a vertically oriented state in which shorter sides are oriented along the horizontal direction or to a horizontally oriented state in which longer sides are oriented along the horizontal direction;

when the automatic layout is supported, transmits to the display device image data for displaying images that conform to the state of the display device that corresponds to the vertically-oriented state or to the horizontally oriented state; and

when the automatic layout is not supported, transmits to the display device image data for displaying images of a predetermined display direction.

### Effect of the Invention

In the present invention, a configuration is adopted whereby, when display screen information that is displayed on the screen of a smartphone that is equipped with a vertical screen and that is operated while being held in a vertical state is acquired and displayed by a tablet device that is equipped with a horizontal screen and that is operated while being held in a horizontal state, and further, when the display screen information that was acquired from the smartphone is not for a horizontal screen, the display screen information that was acquired from the smartphone is rotated 90 degrees and then enlarged at the same vertical/horizontal aspect ratio to be displayed within a layout frame that accords with a horizontal screen, whereby the display screen information that is displayed on a smartphone can be enlarged and displayed to take advantage of the large screen of a tablet device.

In addition, the present invention enables optimum control of the display direction when information of a mobile terminal is displayed on an external device.

### BRIEF DESCRIPTION OF THE DRAWINGS

FIG. 1 shows the configuration for implementing an information display method that uses the tablet device of the present invention.

FIG. 2 is a block diagram showing the principal parts of the circuit construction of the smartphone shown in FIG. 1.

FIG. 3 is a block diagram showing the principal parts of the circuit construction of the tablet device shown in FIG. 1.

FIG. 4 is a flow chart for describing an example of processing when display screen information that is displayed on the display unit of a smartphone is displayed on the display unit of a tablet device in the configuration shown in FIGS. 1-3.

FIG. 5 is a view for describing an example of processing when display screen information that is displayed on the display unit of the smartphone is displayed on the display unit of the tablet device in the configuration shown in FIGS. 1-3.

FIG. 6 is a flow chart for describing another example of the processing when the display screen information that is displayed on the display unit of the smartphone is displayed on the display unit of the tablet device in the configuration shown in FIGS. 1-3.

FIG. 7 is a block diagram showing an example of the configuration of the display system of the present invention.

FIG. 8a is a block diagram showing an example of the configuration of the mobile terminal shown in FIG. 7.

FIG. 8b is a block diagram showing an example of the configuration of the display device shown in FIG. 7.

FIG. 9 is a sequence chart that shows an example of the processing procedure of the display system shown in FIG. 7.

FIG. 10 is a schematic view showing another example of the configuration of the display system of the present invention.

FIG. 11a shows the display method for a case in which display screen information that is displayed on a smartphone screen is for a vertical screen.

FIG. 11b shows the display method for case in which the display screen information that is displayed on a smartphone screen is for a horizontal screen.

### BEST MODE FOR CARRYING OUT THE INVENTION

Exemplary embodiments of the present invention are next described with reference to the accompanying drawings.

FIG. 1 shows a configuration for implementing the information display method that uses the tablet device of the present invention.

As shown in FIG. 1, the present exemplary embodiment is configured with smartphone 100 that is equipped with a vertical screen and that is operated while being held in a vertical state connected to tablet device 200 that is equipped with a horizontal screen and that is operated while being held in a horizontal state. In the present exemplary embodiment, the display screen information that is displayed on the screen of smartphone 100 is acquired and displayed on tablet device 200.

Smartphone 100 has an interface that allows connection with an external apparatus. This interface is a mobile terminal having both the functions of a mobile telephone that is provided with communication means capable of exchanging various data such as image data or a telephone directory and the functions of a personal portable information communication apparatus (PDA: Personal Data Assistant or Personal Digital Assistant).

Tablet device 200 has a larger angle-of-view size than the display screen of smartphone 100. Tablet device 200, by being connected to smartphone 100, acquires and displays display screen information that is displayed on the screen of smartphone 100. This operation is next described in detail.

This smartphone 100 and tablet device 200 have means for enabling the operation of smartphone 100 through the manipulation of the screen of tablet device 200.

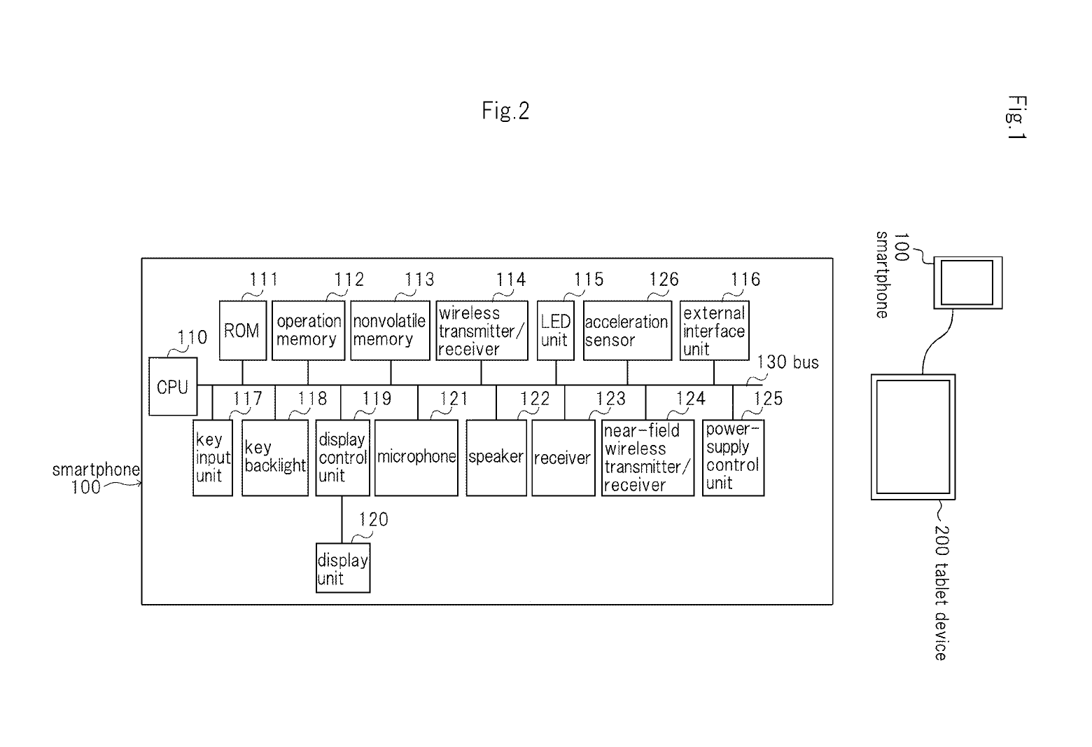

FIG. 2 is a block diagram showing the principal parts of the circuit construction of smartphone 100 that is shown in FIG. 1.

As shown in FIG. 2, smartphone 100 shown in FIG. 1 is made up of: CPU (central processing unit) 110, ROM (Read Only Memory) 111, operation memory 112, nonvolatile memory 113, wireless transmitter/receiver 114, LED unit 115, acceleration sensor 126, external interface unit 116, key input unit 117, key backlight 118, display unit 120, display control unit 119, microphone 121, speaker 122, receiver 123, near-field wireless transmitter/receiver 124, and power-supply control unit 125.

CPU 110 is connected by way of bus 130 to each of the above-described constituent elements within smartphone 100 and controls each constituent element.

ROM 111 stores various control programs such as communication control and power-conservation control for execution by CPU 110 and fixed melody data for sounding various melodies that are used at the time of, for example, voice call connections.

Operation memory 112 is made up of RAM (Random Access Memory) and is configured to store data that are temporarily necessary for the execution of programs by CPU 110.

Nonvolatile memory 113 is a semiconductor memory that is capable of freely implementing deletion and writing of data and whose content is not lost when power is cut. Nonvolatile memory 113 is configured to enable storage of user data and various setting values such as telephone directory data and illumination at the time of incoming calls.

Wireless transmitter/receiver 114 is a circuit that performs wireless transmission and reception of data.

LED unit 115 is made up of LED components that are capable of emitting a plurality of colors. By altering the flashing pattern of each LED, LED unit 115 is used as the light-emitting unit of the illumination function such as at the time of an incoming call.

Acceleration sensor 126 is a sensor used for a pedometer or for determining the vertical direction of the screen display. Acceleration sensor 126 detects the magnitude and direction of acceleration that is applied to smartphone 100.

External interface unit 116 is an interface unit for connecting with an external apparatus. External interface unit 116 is capable of connection with various apparatuses and is made up of several connectors such as a USB that connects to, for example, chargers and personal computers and HDMI that connects with, for example, images and voice.

Key input unit 117 is an input circuit that receives input from various keys (including not only hard keys that are arranged on the outside such as menu keys, home key, clear key, power-supply key, and volume key, but also soft key input realized by input devices such as a touch panel).

Key backlight 118 is used for the illumination of hard keys such as menu keys.

Display unit 120 is a component that displays information. Display unit 120 displays, for example, information that is stored in ROM 111 and nonvolatile memory 113 or information that is received by way of wireless transmitter/receiver 114 or near-field wireless transmitter/receiver 124.

Display control unit 119 is a control circuit that controls the display of display unit 120.

Microphone 121, speaker 122, and receiver 123 are audio components used when carrying out conversation. The voice of a transmitting party is received in microphone 121 and the voice of the communication partner is supplied from speaker 122 or receiver 123.

Near-field wireless transmitter/receiver 124 performs wireless communication that links together apparatuses such as Bluetooth.

Power-supply control unit 125 controls the supply of power from a charging battery (not shown) that is the main power supply of smartphone 100 or external interface 116.

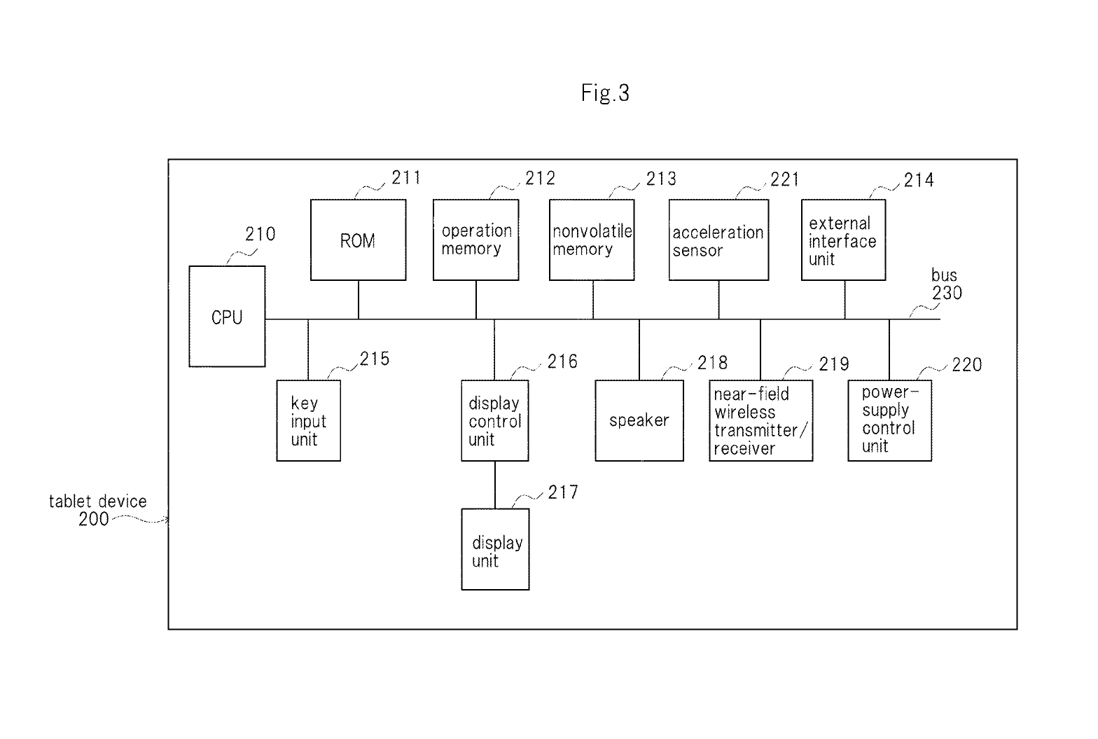

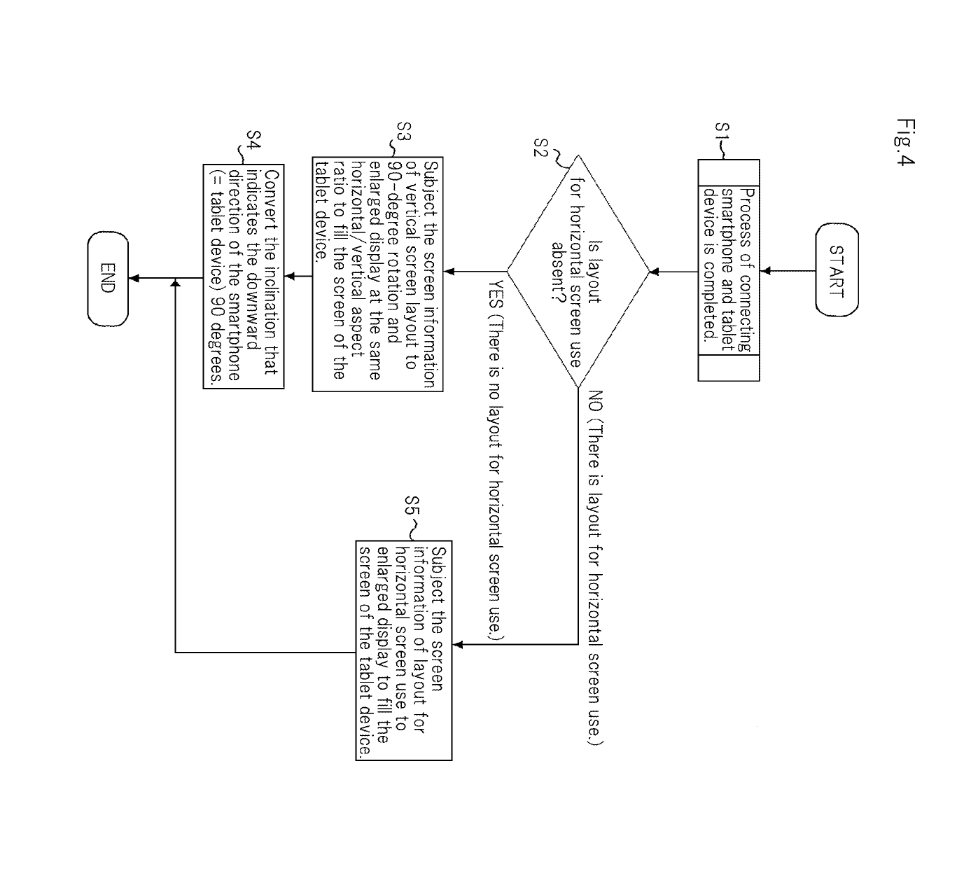

FIG. 3 is a block diagram showing the principal parts of the circuit configuration of tablet device 200 shown in FIG. 1.

As shown in FIG. 3, tablet device 200 shown in FIG. 1 is made up of: CPU (central processing unit) 210, ROM 211, operation memory 212, nonvolatile memory 213, acceleration sensor 221 that is the acceleration detection means, external interface unit 214 that is the information acquisition means, key input unit 215 that is the designation means, display unit 217, display control unit 216, speaker 218, near-field wireless transmitter/receiver 219, and power-supply control unit 220, the control means being made up of CPU 210 and display control unit 216.

CPU 210 is connected to each of the above-described constituent elements in tablet device 200 by way of bus 230 and controls each of the constituent elements.

ROM 211 stores various control programs such as communication control and power conservation control for execution by CPU 210.

Operation memory 212 is constituted by RAM. Operation memory 212 stores data that are temporarily necessary for the execution of programs by CPU 210.

Nonvolatile memory 213 is a semiconductor memory that is capable of freely carrying out the deletion and writing of data, the content of which does not disappear when the power supply is cut.

Acceleration sensor 221 is a sensor used for a pedometer or for determining the vertical direction of the screen display. Acceleration sensor 221 detects the magnitude and direction of acceleration that is applied to tablet device 200.

External interface unit 214 is an interface unit for connecting with external apparatuses. External interface unit 214 is capable of connecting with various apparatuses and is made up of a number of connectors such as USB that connects to, for example, a charger or a personal computer, and HDMI for transmitting and receiving, for example, images or voice. The connection with smartphone 100 in the present exemplary embodiment is realized by way of external interface unit 214.

Key input unit 215 is an input circuit that receives input not only by way of hard keys such as a power-supply key but also by soft key inputs such as by way of an input device such as a touch panel.

Display unit 217 is a component for displaying information. Display unit 217 displays information that is stored in ROM 211 or nonvolatile memory 213, information that is received by way of near-field wireless transmitter/receiver 219, or display screen information that is received as input by way of external interface unit 214.

Display control unit 216 is a control circuit that controls the display of display unit 217.

Speaker 218 supplies sound at times of multimedia reproduction such as moving image reproduction or music reproduction.

Near-field wireless transmitter/receiver 219 performs wireless communication that links together apparatuses such as Bluetooth.

Power-supply control unit 220 controls the supply of power from a charging battery (not shown) that is the main power supply of tablet terminal 200.

Although an example is presented in which tablet device 200 lacks a communication function in the present exemplary embodiment, tablet device 200 may, of course, also be a tablet terminal having communication functions. In this case, tablet device 200 also has a wireless transmitter/receiver similar to smartphone 100.

The following description relates to processing in smartphone 100 and tablet device 200 that are configured as described hereinabove when the display screen information that is displayed on display unit 120 of smartphone 100 is displayed on display unit 217 of tablet device 200.

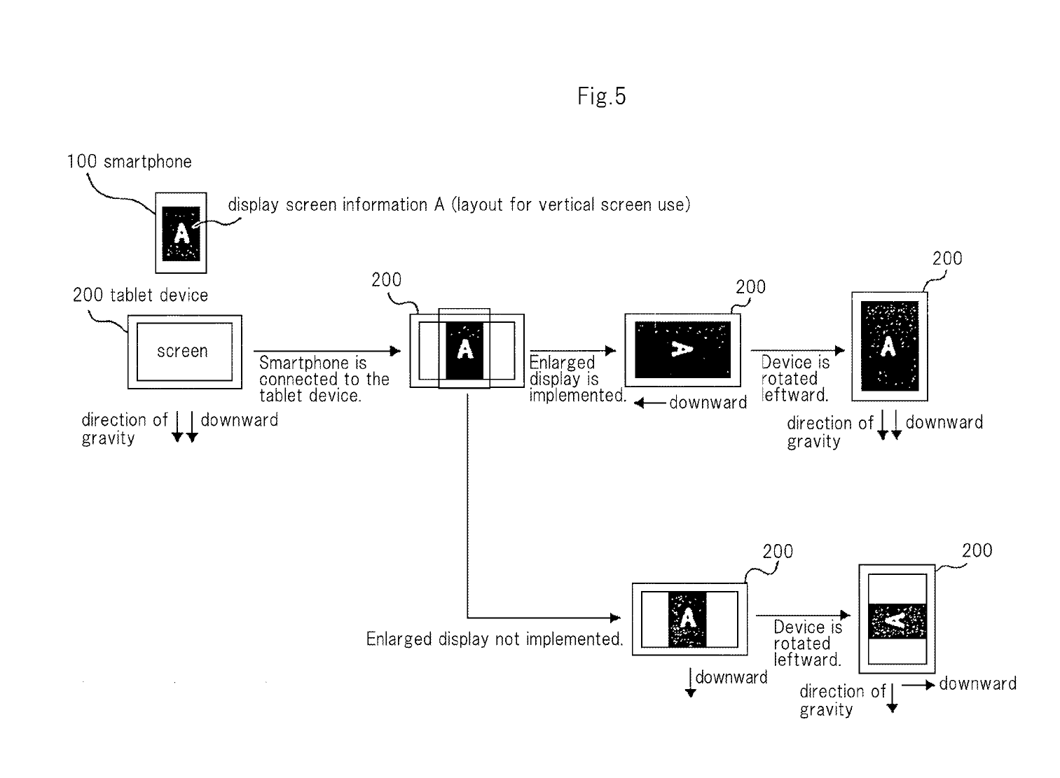

FIG. 4 is a flow chart for describing an example of processing when display screen information that is displayed on display unit 120 of smartphone 100 is displayed on display unit 217 of tablet device 200 in the configuration described in FIGS. 1 to 3. FIG. 5 is a view for describing an example of processing when the display screen information that is displayed on display unit 120 of smartphone 100 is displayed on display unit 217 of tablet device 200 in the configuration shown in FIGS. 1 to 3.

When the process of connecting smartphone 100 and tablet device 200 is completed (Step 1), display screen information A that is displayed on display unit 120 of smartphone 100 is first acquired in tablet device 200 by way of external interface units 116 and 214. At this time, as regards acquired display screen information A, it is determined in CPU 210 whether or not a horizontal screen layout, that is for a horizontal screen, is present (Step 2).

If a horizontal screen layout is not present, in CPU 210 and display control unit 216, acquired display screen information A is rotated 90 degrees to the left and enlarged and displayed at the same vertical/horizontal aspect ratio to fill the screen of display unit 217 of tablet device 200 (Step 3).

In CPU 210, the inclination that indicates the downward direction of tablet device 200 is converted by rotating 90 degrees to the left to align with the direction of gravity and the long sides are recognized as the vertical direction for the acceleration that is detected by acceleration sensor 221 (Step 4). When tablet device 200 is being operated while being held in a horizontal state, the direction that is orthogonal to the long sides is recognized as the vertical direction for the acceleration that was detected by acceleration sensor 221 without converting the inclination that indicates the downward direction of tablet device 200.

Alternatively, when a horizontal screen layout is present, the acquired horizontal screen layout is used in CPU 210 and display control unit 216 to enlarge and display the display screen information A to fill the screen of display unit 217 of tablet device 200 (Step 5).

According to another exemplary embodiment that can be considered, a setting is provided in tablet device 200 regarding whether the display screen information that is acquired from smartphone 100 is to be rotated 90 degrees and enlarged display at the same vertical/horizontal aspect ratio to fill the screen of display unit 217, and when “Do not implement enlarged display” is set, the display screen information that was acquired from smartphone 100 is displayed centered on display unit 217 without being rotated 90 degrees. At this time, a process is not implemented to convert by 90 degrees rotation the inclination that indicates the downward direction of tablet device 200.

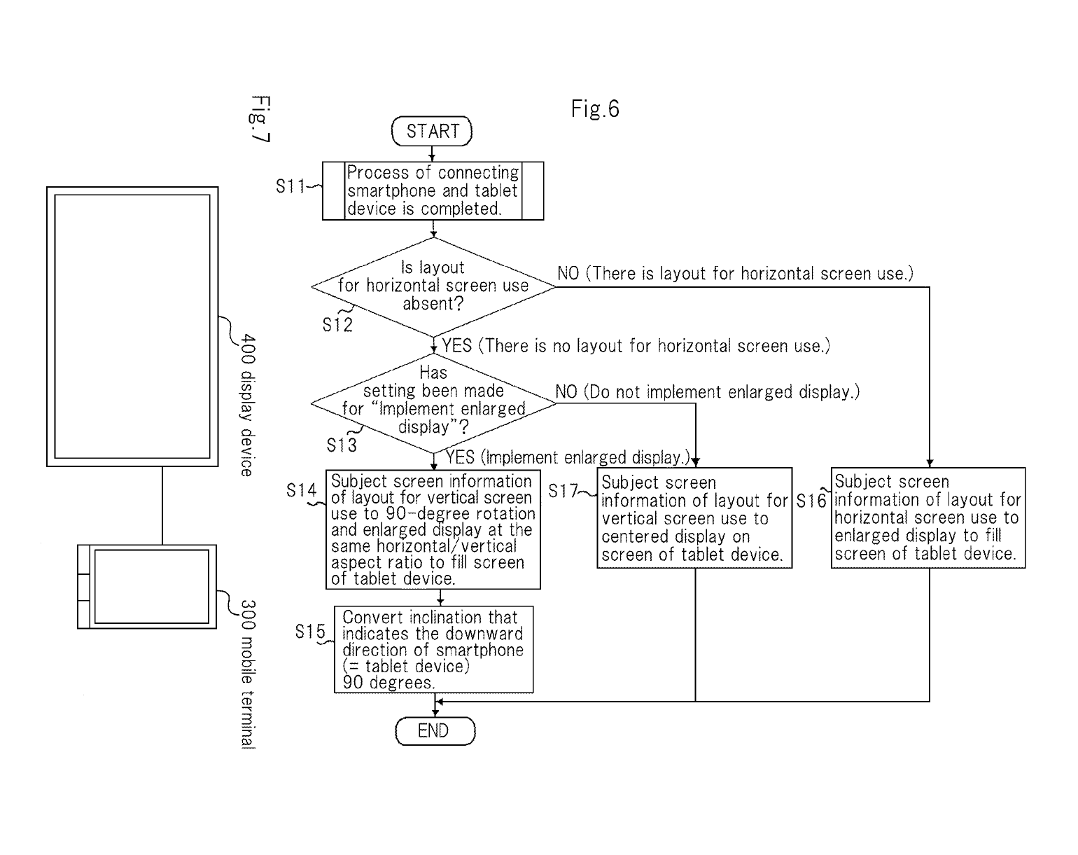

FIG. 6 is a flow chart for describing another example of processing when display screen information that is displayed on display unit 120 of smartphone 100 is displayed on display unit 217 of tablet device 200 in the configuration shown in FIGS. 1-3.

When the process of connecting smartphone 100 and tablet device 200 has been completed (Step 11), the display screen information that is displayed on display unit 120 of smartphone 100 is first acquired by tablet device 200 by way of external interface units 116 and 214, whereupon it is judged in CPU 210 whether horizontal screen layout for use on a horizontal screen is present for the display screen information that was acquired (Step 12).

When a horizontal screen layout is not present, the setting regarding whether to implement 90 degrees rotation of the display screen information that was acquired from smartphone 100 and then implement an enlarged display to fill the screen of display unit 217 at the same vertical/horizontal aspect ratio is reviewed in CPU 210 to judge whether “Implement enlarged display” has been set (Step 13). The setting as to whether to rotate the display screen information, that was acquired from smartphone 100 to 90 degrees and to enlarge the display screen information to fill the screen of display unit 217 at the same vertical/horizontal aspect ratio is instructed beforehand by way of key input unit 215, and CPU 210 refers to this instruction.

If the above-described setting is set to “Implement enlarged display,” in CPU 210 and display control unit 216 the acquired display screen information is rotated leftward by 90 degrees and displayed enlarged at the same vertical/horizontal aspect ratio to fill the screen of display unit 217 of tablet device 200 (Step 14).

In CPU 210, the inclination that indicates the downward direction of tablet device 200 is converted by rotating leftward 90 degrees to agree with the direction of gravity and the direction of the long sides is recognized as the vertical direction for the acceleration that was detected by acceleration sensor 221 (Step 15). When tablet device 200 is being operated while being held in a horizontal state, the direction that is orthogonal to the long sides is recognized as the vertical direction for the acceleration detected by acceleration sensor 221 without converting of the inclination that indicates the downward direction of tablet device 200.

When the horizontal screen layout is present, in CPU 210 and display control unit 216, the acquired horizontal screen layout is used to implement enlarged display of the display screen information to fill the screen of display unit 217 of tablet device 200 (Step 16).

When the above-described setting is set to “Do not implement enlarged display,” the display screen information that was acquired from smartphone 100 is displayed centered on display unit 217 without 90-degree rotation (Step 17).

Thus, when smartphone 100 that is equipped with a vertical screen and operated while being held in a vertical state is connected to tablet device 200 that is equipped with a horizontal screen and operated while being held in a horizontal state, display screen information of the vertical screen layout that is being displayed on display unit 120 of smartphone 100 is rotated 90 degrees and displayed enlarged at the same vertical/horizontal aspect ratio to fill the screen of display unit 217 of tablet device 200, whereby, even when horizontal screen layout does not exist in the display screen information that is being displayed on display unit 120 of smartphone 100, the vertical screen layout can be displayed enlarged on tablet device 200.

Further, at this time, tablet device 200 switches from being held in a horizontal state to being held in a vertical state, but by effecting conversion by implementing 90-degree rotation to agree with the direction of gravity for the inclination that indicates the downward direction of tablet device 200, it is possible to use tablet device 200 with the vertical orientation as a standard even when, for example, using games or applications that use acceleration sensor 221.

In the above-described exemplary embodiment, the display screen information of the vertical screen layout that is displayed on display unit 120 of smartphone 100 is rotated leftward 90 degrees, but the direction of the 90-degree rotation may also be toward the right, and either direction may be freely set. In such cases, however, the direction of rotation when converting the inclination that indicates the downward direction of tablet device 200 must be made the same as this direction.

In addition, the display screen information of vertical screen layout that is displayed on display unit 120 of smartphone 100 is not limited to information that is to be enlarged and displayed to fill the screen of display unit 217 of tablet device 200. Due to the relation of the screen resolution of smartphone 100 and the screen resolution of tablet device 200, the display screen information of the vertical screen layout that is displayed on display unit 120 of smartphone 100 may be information that is to be enlarged and displayed at the same vertical/horizontal aspect ratio in a layout frame that accords with the horizontal screen of tablet device 200. For example, if the screen resolution of smartphone 100 is 800×480 and the screen resolution of tablet device 200 is 1024×600, the display is reduced during processing in which an enlarged display is not implemented. If the screen resolution of smartphone 100 is 800×480 and the resolution of tablet device 200 is 1920×1080, a centered display that is enlarged to double the size of 1600×960 will be produced in the processing for an enlarged display. In other words, the display screen information of vertical screen layout that is displayed on display unit 120 of smartphone 100, rather than being enlarged and displayed to fill the screen of display unit 217 of tablet device 200, will conceivably be reduced and displayed within a predetermined layout frame without alteration of the aspect ratio in the case of “do not enlarge,” or in the case of “enlarge,” will conceivably be enlarged and displayed within the layout frame without alteration of the aspect ratio.

FIG. 7 is a block diagram showing an example of the configuration of the display system of the present invention.

As shown in FIG. 7, the display system of the present invention includes: mobile terminal 300, and display device 400 that is equipped with a display unit having a screen size that is larger than mobile terminal 300 and an input unit (not shown) such as a touch panel or input keys. Mobile terminal 300 and display device 400 are connected by, for example, a cable so as to allow transmission and reception of various data between mobile terminal 300 and display device 400.

An example of mobile terminal 300 is a mobile telephone referred to as a smartphone that is equipped with, for example, known telephone and PDA functions.

An example of display device 400 is, for example, a tablet personal computer.

Mobile terminal 300 and display device 400 are connected by way of a known interface mode such as HDMI (High-Definition Multimedia Interface) for transmitting and receiving pictures or voice or USB (Universal Serial Bus) for transmitting and receiving data with an external apparatus, or by way of a dedicated interface circuit.

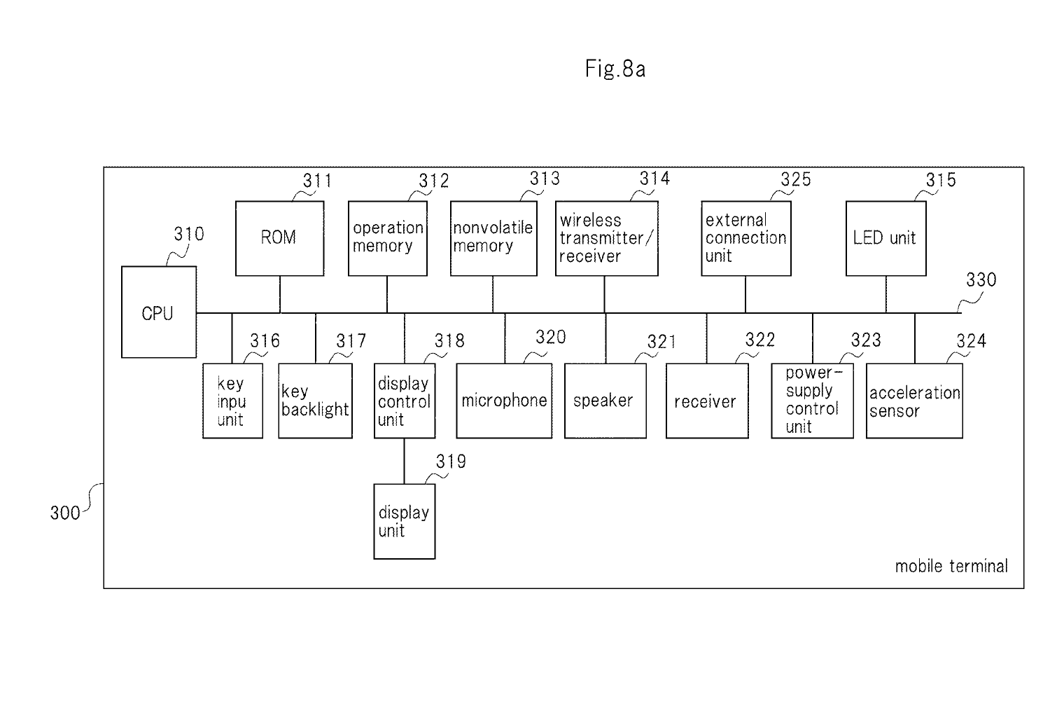

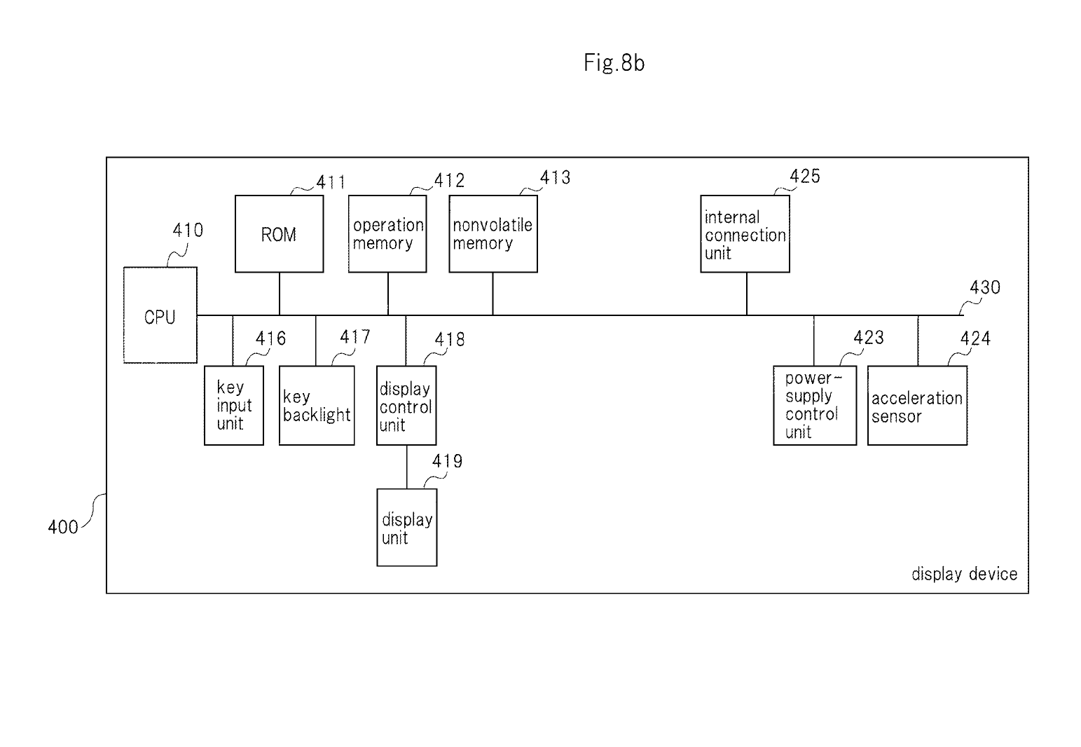

FIG. 8a is a block diagram showing an example of the configuration of the mobile terminal shown in FIG. 7.

As shown in FIG. 8a, mobile terminal 300 of the present exemplary embodiment is a configuration that is equipped with CPU 310, ROM 311, operation memory 312, nonvolatile memory 313, wireless transmitter/receiver 314, LED unit 315, key input unit 316, key backlight 317, display control unit 318, microphone 320, speaker 321, receiver 322, power-supply control unit 323, acceleration sensor 324, and external connection unit 325; these components being connected together by way of bus 330. Display unit 319 is connected to display control unit 318, a secondary battery (not shown) that is the main power supply that supplies necessary power to mobile terminal 300 is connected to power-supply control unit 323, and display device 400 shown in FIG. 7 is connected to external connection terminal 325.

ROM 311 is nonvolatile memory in which are stored control programs for the execution of various processes by CPU 310. CPU 310, by executing processing in accordance with control programs that are stored in ROM 311, both realizes functions as a known smartphone and realizes functions as mobile terminal 100 to be described that are provided in the display system of the present invention.

Operation memory 312 temporarily saves data that are necessary in processing that accords with the control programs carried out by CPU 310. For example, RAM is used in operation memory 312.

Nonvolatile memory 313 is a nonvolatile memory that allows rewriting of memory content and in which, for example, telephone directory data, various set values, and user data are stored.

Wireless transmitter/receiver 314 is a known wireless circuit for transmitting and receiving various data such as speech and images by wireless communication.

LED unit 315 is provided with a plurality of LEDs (Light Emitting Diodes) that emit different colors. LED unit 315 is an electronic component that is used for notifying a user of an incoming call or receipt of electronic mail by varying, for example, the flashing pattern of each LED.

Display unit 319 is, for example, a liquid crystal display or an organic EL panel that displays images in accordance with image information or pictures signals that are supplied from CPU 310. A touch panel for entering information such as letters, numbers, and symbols as input based on displayed images to mobile terminal 300 may also be installed on the display surface of display unit 319.

Display control unit 318 is a control circuit that implements control for displaying images or pictures on display unit 319.

Key input unit 316 is an input circuit that receives information such as letters, numbers, symbols, or instructions that are applied as input by a user using a touch panel or input keys realized by hardware that are necessary for turning the power supply ON/OFF or for various settings.

Key backlight 317 is a light-emitting unit that lights or illuminates the input keys. Key backlight 317 can emit light having a plurality of colors.

Microphone 320, speaker 321, and receiver 322 are audio components for voice communication that are used when mobile terminal 300 is used as a telephone. The voice of the transmitting party is applied as input from microphone 320, and the voice of the partner is supplied from speaker 321 or receiver 322.

Power-supply control unit 323 controls the supply of power from the secondary battery (not shown) to mobile terminal 300.

Acceleration sensor 324 is an inclination detection means that supplies a value according to the inclination or movement of mobile terminal 300. Acceleration sensor 324 is used for determining the vertical direction of the display screen. A sensor of any of a known mechanical mode, optical mode, or semiconductor mode may be used in acceleration sensor 324.

External connection unit 325 is an interface that is provided with connectors that conform to USB or HDMI and that connects with display device 400 so as to allow the transmission and reception of data. External connection unit 325 may be provided with a dedicated interface circuit for connecting with display device 400 shown in FIG. 7 as described above.

FIG. 8b is a block diagram showing an example of the configuration of the display device shown in FIG. 7.

As shown in FIG. 8b, display device 400 of the present exemplary embodiment is a configuration equipped with CPU 410, ROM 411, operation memory 412, nonvolatile memory 413, key input unit 416, key backlight 417, display control unit 418, power-supply control unit 423, acceleration sensor 424, and internal connection unit 425; these components being connected together by way of bus 430. Display unit 419 is connected to display control unit 418, a secondary battery (not shown) that is the main power supply that supplies necessary power to display device 400 is connected to power-supply control unit 423, and, for example, mobile terminal 300 shown in FIG. 8a is connected to internal connection unit 425.

ROM 411 is nonvolatile memory that stores control programs for executing various processes by CPU 410. CPU 410, by executing processes in accordance with the control programs that are stored in ROM 411, is able to functions, for example, both as a tablet terminal and as display device 400 described below that are provided in the display system of the present invention.

Operation memory 412 temporarily saves data that are necessary in processing according to the control programs by CPU 410. As an example, RAM is used in operation memory 412.

Nonvolatile memory 413 is a nonvolatile memory that allows rewriting of the memory content and stores various set values and user data.

Internal connection unit 425 is equipped with, for example, connectors that conform to USB for connecting with external apparatuses and HDMI for transmitting and receiving images and voice, and is able to connect with a variety of apparatuses. Display device 400 is connected with mobile terminal 300 shown in FIG. 8a by way of internal connection unit 425. In addition, internal connection unit 425 may be provided with a dedicated interface circuit for connecting with mobile terminal 300 shown in FIG. 8a as described above.

Display unit 429 is, for example, a liquid crystal display or an organic EL panel that displays images in accordance with image information or picture signals that are supplied from CPU 410. A touch panel for receiving as input information such as letters, numbers, or symbols to display device 400 based on displayed images may be installed on the display surface of display unit 419.

Display control unit 418 is a control circuit that implements control for displaying images or pictures on display unit 419.

Key input unit 416 is an input circuit that receives information such as letters, numbers, symbols, or instructions that a user applies as input using, for example, a touch panel or input keys realized by hardware and that are necessary for turning the power supply ON/OFF or for making various settings.

Power-supply control unit 423 controls the supply of power from a secondary battery (not shown) to display device 400.

Acceleration sensor 424 is an inclination detection means that supplies values according to the inclination or movement of display device 400. Acceleration sensor 424 is used for determining the vertical direction of the display screen. A sensor of any known mechanical mode, optical mode, or semiconductor mode may be used for acceleration sensor 424.

Although FIG. 8b shows an example of the configuration of display device 400 that is not equipped with telephone functions, telephone functions may be equipped by providing display device 400 with wireless transmitter/receiver 314, microphone 320, speaker 321 and receiver 322 similar to mobile terminal 300 shown in FIG. 8a.

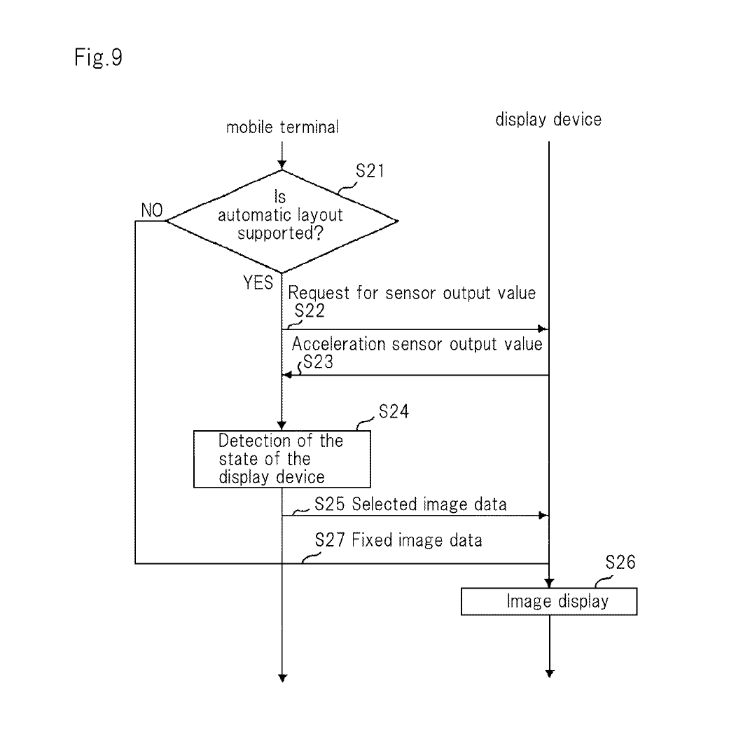

FIG. 9 is a sequence chart showing an example of the processing procedure of the display system shown in FIG. 7.

The processes shown in FIG. 9 are realized by the processing operation executed by CPU 310 provided in mobile terminal 300 in accordance with control programs that are stored in ROM 311 and by the processing operation executed by CPU 410 provided in display device 400 in accordance with control programs that are stored in ROM 411.

When mobile terminal 300 is not connected to display device 400, mobile terminal 300 detects the inclination of its own device based on the output value of acceleration sensor 324 and converts the layout of the images that are displayed on display unit 319 according to the vertically oriented state in which the short sides of mobile terminal 300 are oriented in the horizontal direction or the horizontally oriented state in which the long sides of mobile terminal 300 are oriented in the horizontal direction. The images that are displayed in accordance with the vertically oriented state of mobile terminal 300 are hereinbelow referred to as vertical layout, and the images that are displayed in accordance with the horizontally oriented state of mobile terminal 300 are referred to as horizontal layout. Normally, whether mobile terminal 300 automatically displays a vertical or horizontal layout in accordance with its inclination depends on whether the application software that is operating in mobile terminal 300 supports automatic layout. Automatic layout refers to a function that enables image display according to a vertically oriented state and a horizontally oriented state. The vertical layout and horizontal layout may be different images and are not necessarily images in which the arrangements of screen components are equal, i.e., are not necessarily identical images.

On the other hand, when mobile terminal 300 is connected to display device 400 and the information of mobile terminal 300 is displayed on display device 400, as shown in FIG. 9, mobile terminal 300 of the present exemplary embodiment first judges whether the application software that is operating on mobile terminal 300 supports automatic layout (Step 21).

If automatic layout is supported, mobile terminal 300 requests that the output value of acceleration sensor 424 be transmitted to display device 400 (sensor output value request)(Step 22). Display device 400 transmits the output value of acceleration sensor 424 to mobile terminal 300 in accordance with the request from mobile terminal 300 (Step 23). Display device 400 may also transmit the output value of acceleration sensor 424 to mobile terminal 300 at the time of verifying the connection with mobile terminal 300.

Mobile terminal 300 determines the inclination of display device 400 based on the output value of acceleration sensor 424 that was received from display device 400 (Step 24), judges whether display device 400 is in a vertically oriented state with the short sides of display device 400 oriented in the horizontal direction or is in a horizontally oriented state with the long sides of display device 400 oriented in the horizontal direction, selects images that conform to the state of display device 400, and transmits to display device 400 image data (selected image data) for displaying the selected images (Step 25). For example, mobile terminal 300 transmits horizontal layout image data to display device 400 when display device 400 is in the horizontally oriented state, and mobile terminal 300 transmits vertical layout image data to display device 400 when display device 400 is in the vertically oriented state.

Display device 400 displays images in accordance with the horizontal layout or vertical layout image data (selected image data) that were transmitted from mobile terminal 300 (Step 26).

When the application software that is operating on mobile terminal 300 does not support automatic layout, mobile terminal 300 transmits to display device 400 image data (fixed image data) that are displayed by the application software for displaying images in a display direction that was determined in advance (Step 27). In this case, display device 400 should display images based on the fixed image data that were transmitted from mobile terminal 300. At this time, display device 400 may detect the inclination of its own device based on the output value of acceleration sensor 424 and then, according to the vertically oriented state or horizontally oriented state, display the fixed layout that was transmitted from mobile terminal 300 in vertical or horizontal orientation.

Normally, however, not only the screen size, but also the screen resolution will also differ between mobile terminal 300 and display device 400 such as a tablet terminal, the tablet terminal usually having higher screen resolution (smaller dot pitch) than mobile terminal 300. When image data that conform to the image resolution of mobile terminal 300 are transmitted without alteration to a tablet terminal in such cases, an image that is even smaller than the screen of mobile terminal 300 is displayed on the tablet terminal.

In response to this problem, mobile terminal 300 of the present exemplary embodiment both selects image data that is displayed in a vertical layout or horizontal layout according to the inclination of display device 400 and executes an enlargement process to enlarge and display the image and then transmits the image data that follow the enlargement process to display device 400. If the application software that is operating on mobile terminal 300 does not support automatic layout, mobile terminal 300 may execute only an enlargement process that enlarges the image.

As the method of enlarging a display image, a method exists in which, for example, a video controller provided in mobile terminal 300 converts the screen resolution by a known method such as additive color mixture. In this case, mobile terminal 300 need to enlarge the display image up to the screen resolution of display unit 419 while maintaining the aspect ratio of the screen resolution of mobile terminal 300. In other words, image data that conform to the screen resolution of mobile terminal 300 need to be converted to image data that conform to the screen resolution of display device 400. However, a portion of the display image may be trimmed. For example, if the screen resolution of mobile terminal 300 is 480×800, enlargement up to a screen resolution of 900×1600 and trimming of 60 dots in the vertical direction can be done.

In the enlargement process, enlargement up to the screen resolution of display device 400 is not necessary, and enlargement may be set to an integer multiple of the screen resolution of mobile terminal 300 if the screen resolution is less than the screen resolution of display device 400. For example, if the screen resolution of 480×800 of mobile terminal 300 is displayed on display device 400 having a screen resolution of 1080×1920, the image should be enlarged up to twice the screen resolution at 960×1600 and displayed in the center of display unit 419.

If display device 400 is equipped with a known screen enlargement/reduction function, image data of a predetermined (normalized) screen resolution are transmitted to display device 400 from mobile terminal 300, and display device 400 may use the enlargement/reduction function to convert to a predetermined screen resolution according to the screen resolution of display unit 419. “Normalized” refers to a process of conversion to image data of a known standard screen resolution such as WVGA, SVGA, XGA, or SXGA. For example, mobile terminal 300 needs to convert image having screen resolution of 800×400 to image data having a screen resolution of 1280×720 and needs to transmit the data to display device 400, and further, display device 400 needs to convert image data with a screen resolution of 1280×720 to image data having a screen resolution of 1920×1080. In this case, the load of the enlargement process of the screen resolution by mobile terminal 300 can be lightened while maintaining display quality. However, a high screen resolution display following normalization supplied from mobile terminal 300 (for example, the above-described 1280×720) requires that display device 400 have a high processing capability for the screen resolution conversion, thereby entailing an increase in the cost of display device 400. Accordingly, the screen resolution of image data transmitted to display device 400 from mobile terminal 300 is preferably determined with due consideration given to the processing capability of display device 400. In such cases, a portion of the display images may be trimmed. For example, if the screen resolution of mobile terminal 300 is 800×480, image data that have been normalized to a screen resolution of 720×480 by trimming 40 dots in the vertical direction need to be transmitted to display device 400, and display device 400 need to use the screen enlargement/reduction function to subject the image data to an enlargement process and then to display the image data.

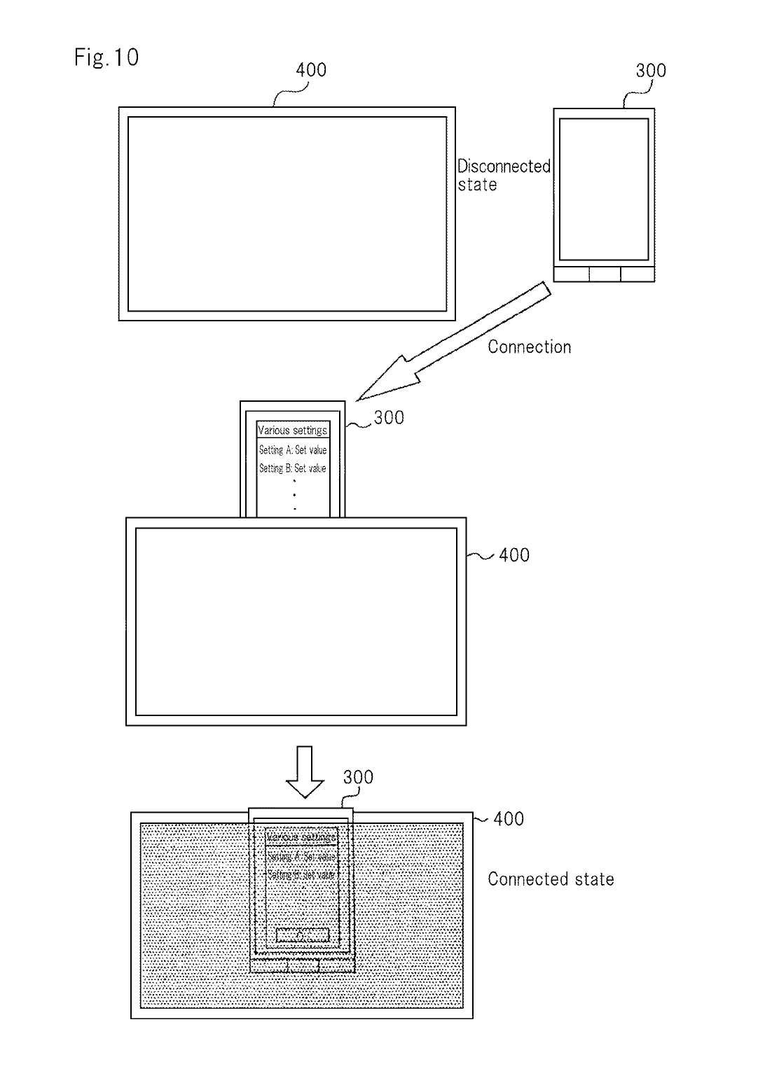

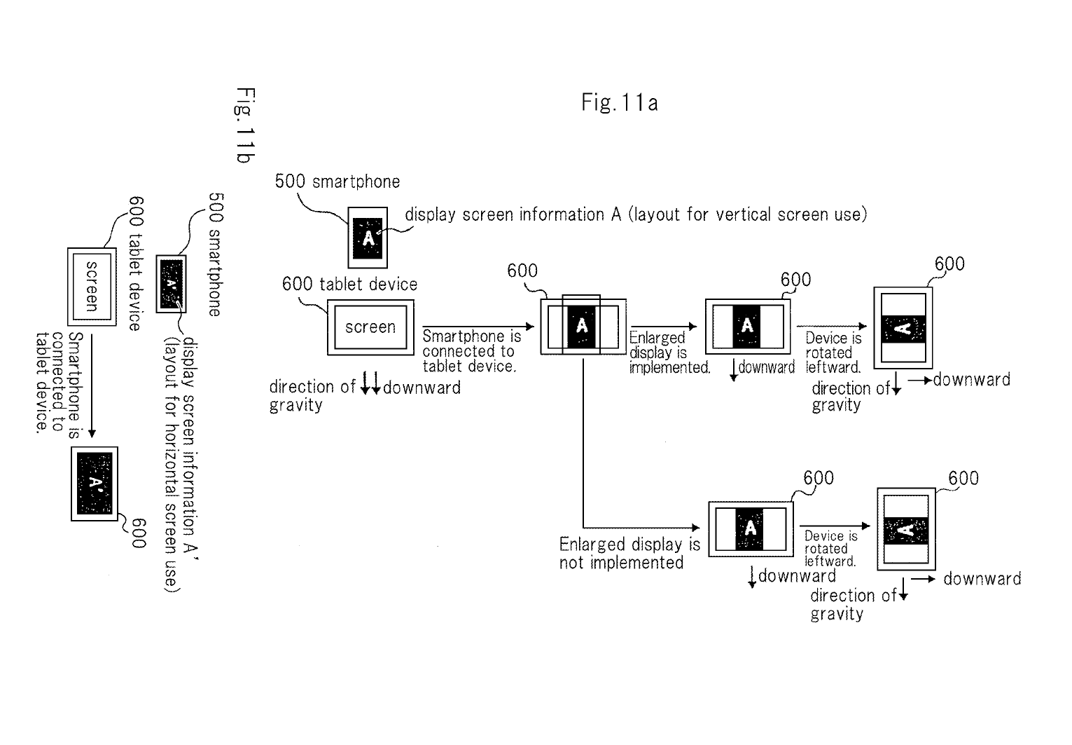

In addition, display device 400 is not limited to a configuration in which display device 400 is connected to mobile terminal 300 through the use of a cable as shown in FIG. 7, and for example, as with display device 400 shown in FIG. 10, the configuration of display device 400 may also be provided with an interface that enables connection to mobile terminal 300 through the provision of a housing into which mobile terminal 300 can be inserted/removed and then accommodating mobile terminal 300 in this housing. FIG. 10 shows an example of the configuration in which mobile terminal 300 is inserted from a long side of display device 400, but a configuration in which mobile terminal 300 is inserted from a short side of display device 400 is also possible. In FIG. 10, an example of a configuration is shown in which mobile terminal 300 is inserted into display device 400 such that display unit 319 of mobile terminal 300 and display unit 419 of display device 400 face the same direction, but a configuration is also possible in which mobile terminal 300 is inserted into display device 400 such that display unit 319 of mobile terminal 300 and display unit 419 of display device 400 face opposite directions.

In this configuration as well, mobile terminal 300 changes the layout of images that are displayed on display device 400 based on the output value of acceleration sensor 424 that is transmitted from display device 400. For example, when display device 400 is in a horizontally oriented state, mobile terminal 300 needs to transmit image data of horizontal layout to display device 400, and when display device 400 is in a vertically oriented state, mobile terminal 300 needs to transmit image data of vertical layout to display device 400.

In a configuration in which mobile terminal 300 is housed in display device 400 as shown in FIG. 10, the relation between the screen orientation (vertical orientation and horizontal orientation) of each apparatus is fixed when display device 400 and mobile terminal 300 are connected. Accordingly, if the direction of installation of mobile terminal 300 with respect to display device 400 (the relation of the screen orientations when installed) is known in advance, the inclination of display device 400 (the vertically oriented state or horizontally oriented state) can also be determined by the output value of acceleration sensor 324 that is provided in mobile terminal 300. In this case, the need to provide acceleration sensor 424 in display device 300 is eliminated, and the cost of display device 400 can be reduced.

According to the display system of the present exemplary embodiment, if mobile terminal 300 supports automatic layout, mobile terminal 300 transmits to display device 400 image data for displaying images that correspond to the state of display device 400 (vertically oriented state or horizontally oriented state), and if mobile terminal 300 does not support automatic layout, mobile terminal 300 transmits to display device 400 image data for displaying images of a predetermined display direction. Thereby, mobile terminal 300 can implement optimum control of the display direction when the information of mobile terminal 300 is to be displayed on an external device (display device 400). By enlarging the images that are displayed on display device 400, the inconvenience of having images displayed that are smaller than on mobile terminal 300 is eliminated.

Although an example of the configuration has been shown in the present exemplary embodiment in which display device 400 is provided with power-supply control unit 423 and necessary power is supplied from a secondary battery that is connected to power-supply control unit 423, a configuration is also possible in which display device 400 is supplied with power from mobile terminal 300 by way of external connection unit 325 and internal connection unit 425.

### Notes

### Note 1

A tablet device is equipped with a horizontal screen, is operated while being held in a horizontal state, and that is configured to allow connection to a smartphone that is equipped with a vertical screen and that is operated while being held in a vertical state, the tablet device including:

information acquisition means configured to acquire display screen information that is displayed on the screen of the smartphone; and

control means configured to, when the display screen information that was acquired by the information acquisition means is not for a horizontal screen, rotate the display screen information 90 degrees and to enlarge and display the display screen information at the same vertical/horizontal aspect ratio within a layout frame that accords with the horizontal screen.

### Note 2

In the tablet device according to Note 1, the tablet device further includes:

acceleration detection means that detects acceleration applied to the tablet device; wherein the control means, when the tablet device is being operated while being held in a horizontal state, recognizes the direction that is orthogonal to the longitudinal direction of the horizontal screen as the vertical direction for the acceleration that was detected in the acceleration detection means, and when rotating the display screen information, that was acquired by the information acquisition means, 90 degrees and enlarging and display the display screen information, recognizes as the vertical direction the longitudinal direction of the horizontal screen for the acceleration that was detected by the acceleration detection means.

### Note 3

In the tablet device according to Note 2, the tablet device further includes:

designation means for designating whether to rotate the display screen information, that was acquired by the information acquisition means, 90 degrees and to enlarge and display the display screen information;

wherein the control means, only when designated by the designation means to rotate the display screen information, that was acquired by the information acquisition means, 90 degrees and to enlarge and display the display screen information, both rotates the display screen information, that was acquired by the information acquisition means, 90 degrees and enlarges and displays the display screen information, and further, recognizes as the vertical direction the longitudinal direction of the horizontal screen for the acceleration that was detected by the acceleration detection means.

### Note 4

In the tablet device according to any one of Notes 1 to 3, the control means is capable of freely setting the 90-degree rotation to either the leftward direction or rightward direction for a case in which the tablet device is being operated while being held in a horizontal state.

### Note 5

In the tablet device according to any one of Notes 1 to 4, the control means rotates the display screen information, that was acquired by the information acquisition means, 90 degrees and enlarges and displays the display screen information at the same vertical/horizontal aspect ratio to fill the horizontal screen.

### Note 6

An information display method of acquiring and displaying display screen information that is displayed on the screen of a smartphone that is equipped with a vertical screen and that is operated while being held in a vertical state on a tablet device that is equipped with a horizontal screen and that is operated while being held in a horizontal state, wherein:

when display screen information that was acquired from the smartphone is not for horizontal screen use, is rotated 90 degrees and enlarged and displayed, at the same vertical/horizontal aspect ratio, within a layout frame according to the horizontal screen.

### Note 7

In the information display method according to Note 6, when the tablet device is being operated while being held in a horizontal state, the direction that is orthogonal to the longitudinal direction of the horizontal screen is recognized as the vertical direction for the detected acceleration, and when the display screen information that was acquired from the smartphone is rotated 90 degrees and enlarged and displayed, the longitudinal direction of the horizontal screen is recognized as the vertical direction for the detected acceleration.

### Note 8

In the information display method according to Note 7, only when the display screen information, that was acquired from the smartphone, is rotated 90 degrees, and that was enlarged and displayed, has been designated, will the display screen information, that was acquired from the smartphone, be rotated 90 degrees and enlarged and displayed, and will the longitudinal direction of the horizontal screen be recognized as the vertical direction for the acceleration that was detected.

### Note 9

In the information display method according to any one of Notes 6 to 8, for a case in which the tablet device being operated while being held in a horizontal state, the 90-degree rotation can be freely set to either the rightward direction or the leftward direction.

### Note 10

In the information display method according to any one of Notes 6 to 9, the display screen information that was acquired from the smartphone is rotated 90 degrees and enlarged and displayed at the same vertical/horizontal aspect ratio to fill the horizontal screen.

### Note 11

A display system that comprising:

a mobile terminal that is equipped with an interface that connects with an external apparatus so as to allow transmission and reception of information; and

a display device that is equipped with the interface that connects with the mobile terminal so as to allow transmission and reception of information and a display unit having a screen size larger than that of the mobile terminal,

wherein the mobile terminal:

when connected with the display device by way of the interface, judges the possibility of automatic layout that displays images that conforms to a vertically oriented state in which shorter sides are oriented with the horizontal direction or to a horizontally oriented state in which longer sides are oriented with the horizontal direction;

when the automatic layout is supported, transmits to the display device image data for displaying images that conform to the state of the display device that corresponds to the vertically oriented state or the horizontally oriented state; and

when the automatic layout is not supported, transmits to the display device image data for displaying images of a display direction that was determined in advance.

### Note 12

In the display system according to Note 11, the mobile terminal, when connected to the display device by way of the interface, executes an enlarging process for displaying enlarged images on the display device and transmits the enlarged images to the display device image data that follow the enlarging process.

### Note 13

In the display system according to Note 12, the mobile terminal converts image data that conform to screen resolution of the mobile terminal to image data that conform to screen resolution of the display device.

### Note 14

In the display system according to Note 12, the mobile terminal converts image data that conform to the screen resolution of the mobile terminal to image data that have screen resolution that is no greater than the screen resolution of the display device and that is an integer multiple of the screen resolution of the mobile terminal.

### Note 15

In the display system according to in any one of Notes 11 to 14, the display device is equipped with a housing unit that accommodates the mobile terminal such that the mobile terminal can be inserted or removed, the interface being provided in the housing unit.

### Note 16

In the display system according to any one of Notes 11 to 15, the display device includes inclination detection means that supplies a value that accords with the inclination or movement of the display device.

### Note 17

A mobile terminal can connect to a display device that is provided in a display system according to any one of Notes 11 to 16.

### Note 18

A display device can connect with a mobile terminal that is provided in a display system according to any one of Notes 11 to 16.

### Note 19

A display method for, when a mobile terminal that is equipped with an interface that connects with an external apparatus so as to allow the transmission and reception of information, and a display device that is equipped with the interface that connects with the mobile terminal so as to allow the transmission and reception of information and a display unit that has a screen size larger than the mobile terminal are connected by way of the interface, displaying information of the mobile terminal on the display device; wherein the mobile terminal:

when connected to the display device by way of the interface, judges the possibility of automatic layout that displays images that conform to a vertically oriented state in which shorter sides are oriented along the horizontal direction or to a horizontally oriented state in which longer sides are oriented along the horizontal direction;

when the automatic layout is supported, transmits to the display device image data for displaying images that conform to the state of the display device that corresponds to the vertically-oriented state or to the horizontally oriented state; and

when the automatic layout is not supported, transmits to the display device image data for displaying images of a predetermined display direction.

### Note 20

In the display method according to Note 19, the mobile terminal, when connected to the display device by way of the interface, executes an enlarging process for displaying enlarged images on the display device and transmits to the display device image data that follow the enlarging process.

### Note 21

In the display method according to Note 20, the mobile terminal converts image data that conform with the screen resolution of the mobile terminal to image data that conform with the screen resolution of the display device.

### Note 22

In the display method according to Note 20, the mobile terminal converts image data that conform with the screen resolution of the mobile terminal to image data of a screen resolution lower than that of the display device and having an integer multiple of the screen resolution of the mobile terminal.

Although the invention of the present application has been described with reference to exemplary embodiments, the invention of the present application is not limited to the above-described exemplary embodiments. The configuration and details of the invention of the present application are open to various modifications within the scope of the invention of the present application that will be clear to one of ordinary skill in the art.

This application claims the benefits of priority based on Japanese Patent Application No. 2011-267657 for which application was submitted on Dec. 7, 2011 and Japanese Patent Application No. 2011-275599 for which application was submitted on Dec. 16, 2011 and incorporates by citation all of the disclosures of these applications.

1. A tablet device that is equipped with a horizontal screen, that is operated while being held in a horizontal state, and that is configured to allow connection to a smartphone that is equipped with a vertical screen and that is operated while being held in a vertical state, comprising:
information acquisition means configured to acquire display screen information that is displayed on the screen of said smartphone; and
control means configured to, when said display screen information that was acquired by said information acquisition means is not for a horizontal screen, rotate said display screen information 90 degrees and to enlarge and display said display screen information at the same vertical/horizontal aspect ratio within a layout frame that accords with said horizontal screen.

2. The tablet device according to claim 1, further comprising:
acceleration detection means that detects acceleration applied to said tablet device;
wherein said control means, when the tablet device is being operated while being held in a horizontal state, recognizes the direction that is orthogonal to the longitudinal direction of said horizontal screen as the vertical direction for the acceleration that was detected in the acceleration detection means, and when rotating the display screen information, that was acquired by said information acquisition means, 90 degrees and enlarging and display said display screen information, recognizes as the vertical direction said longitudinal direction of said horizontal screen for the acceleration that was detected by the acceleration detection means.

3. The tablet device according to claim 2, further comprising:
designation means for designating whether to rotate said display screen information, that was acquired by said information acquisition means, 90 degrees and to enlarge and display said display screen information;
wherein said control means, only when designated by said designation means to rotate the display screen information, that was acquired by said information acquisition means, 90 degrees and to enlarge and display the display screen information, both rotates the display screen information, that was acquired by said information acquisition means, 90 degrees and enlarges and displays said display screen information, and further, recognizes as the vertical direction said longitudinal direction of said horizontal screen for the acceleration that was detected by said acceleration detection means.

4. The tablet device according to claim 1, wherein:
said control means is capable of freely setting said 90-degree rotation to either the leftward direction or rightward direction for a case in which said tablet device is being operated while being held in a horizontal state.

5. The tablet device according to claim 1, wherein said control means rotates the display screen information, that was acquired by said information acquisition means, 90 degrees and enlarges and displays the display screen information at the same vertical/horizontal aspect ratio to fill said horizontal screen.

6. An information display method of acquiring and displaying display screen information that is displayed on the screen of a smartphone that is equipped with a vertical screen and that is operated while being held in a vertical state on a tablet device that is equipped with a horizontal screen and that is operated while being held in a horizontal state, wherein:
when display screen information that was acquired from said smartphone is not for horizontal screen use, is rotated 90 degrees and enlarged and displayed, at the same vertical/horizontal aspect ratio, within a layout frame according to said horizontal screen.

7. The information display method according to claim 6, wherein:
when said tablet device is being operated while being held in a horizontal state, the direction that is orthogonal to said longitudinal direction of said horizontal screen is recognized as the vertical direction for the detected acceleration, and when the display screen information that was acquired from said smartphone is rotated 90 degrees and enlarged and displayed, said longitudinal direction of said horizontal screen is recognized as the vertical direction for the detected acceleration.

8. The information display method according to claim 7, wherein: only when the display screen information, that was acquired from said smartphone, is rotated 90 degrees, and that was enlarged and displayed, has been designated, will the display screen information, that was acquired from said smartphone, be rotated 90 degrees and enlarged and displayed, and will said longitudinal direction of said horizontal screen be recognized as the vertical direction for said acceleration that was detected.

9. The information display method according to claim 6, wherein: for a case in which said tablet device being operated while being held in a horizontal state, said 90-degree rotation can be freely set to either the rightward direction or the leftward direction.

10. The information display method according to claim 6, wherein display screen information that was acquired from said smartphone is rotated 90 degrees and enlarged and displayed at the same vertical/horizontal aspect ratio to fill said horizontal screen.

11. A display system that comprising:
a mobile terminal that is equipped with an interface that connects with an external apparatus so as to allow transmission and reception of information; and
a display device that is equipped with said interface that connects with said mobile terminal so as to allow transmission and reception of information and a display unit having a screen size larger than that of said mobile terminal,
wherein said mobile terminal:
when connected with said display device by way of said interface, judges the possibility of automatic layout that displays images that conforms to a vertically oriented state in which shorter sides are oriented with the horizontal direction or to a horizontally oriented state in which longer sides are oriented with the horizontal direction;
when said automatic layout is supported, transmits to said display device image data for displaying images that conform to the state of said display device that corresponds to said vertically oriented state or said horizontally oriented state; and
when said automatic layout is not supported, transmits to said display device image data for displaying images of a display direction that was determined in advance.

12. The display system according to claim 11, wherein said mobile terminal:
when connected to said display device by way of said interface, executes an enlarging process for displaying enlarged images on said display device and transmits said enlarged images to said display device image data that follow the enlarging process.

13. The display system according to claim 12, wherein said mobile terminal converts image data that conform to screen resolution of said mobile terminal to image data that conform to screen resolution of said display device.

14. The display system according to claim 12, wherein said mobile terminal converts image data that conform to the screen resolution of said mobile terminal to image data that have screen resolution that is no greater than the screen resolution of said display device and that is an integer multiple of the screen resolution of said mobile terminal.

15. The display system according to claim 11, wherein said display device comprises inclination detection means that supplies a value that accords with the inclination or movement of said display device.

16. A mobile terminal that can connect to a display device provided in the display system as described in claim 11.

17. A display device that can connect to a mobile terminal that is provided in the display system as described in claim 11.

18. A display method for, when a mobile terminal that is equipped with an interface that connects with an external apparatus so as to allow the transmission and reception of information, and a display device that is equipped with said interface that connects with said mobile terminal so as to allow the transmission and reception of information and a display unit that has a screen size larger than said mobile terminal are connected by way of said interface, displaying information of said mobile terminal on said display device; wherein said mobile terminal:
when connected to said display device by way of said interface, judges the possibility of automatic layout that displays images that conform to a vertically oriented state in which shorter sides are oriented along the horizontal direction or to a horizontally oriented state in which longer sides are oriented along the horizontal direction;
when said automatic layout is supported, transmits to said display device image data for displaying images that conform to the state of said display device that corresponds to said vertically-oriented state or to said horizontally oriented state; and
when said automatic layout is not supported, transmits to said display device image data for displaying images of a predetermined display direction.
